(19) United States
(12) Patent Application Publication
(10) Pub. No.: US 2005/0038554 A1
(43) Pub. Date: Feb. 17, 2005

(54) Inspection and metrology module cluster tool

(76) Inventor: Cory Watkins, Chanhassen, MN (US)

Correspondence Address: DICKE BILLIG & CZAJA, PLLC;ATTN: JOHN VASUTA, 100 SOUTH FIFTH STREET, SUITE 2250, MINNEAPOLIS, MN, 55402, US

(21) Appl. No.: 10/890,761

(22) Filed: Jul. 14, 2004

Related U.S. Application Data
(60) Provisional application No. 60/486,955, filed on Jul. 14, 2003.

(51) Int. Cl. G06F 7/00

(52) U.S. Cl. 700/213

(57) ABSTRACT

A semiconductor inspection tool includes a robot, a first wafer carrier proximate the robot, a first wafer inspection module proximate the robot, a second wafer inspection module proximate the robot, and a controller configured for controlling the robot to pass wafers between the first wafer carrier, the first wafer inspection module, and the second wafer inspection module.

### CROSS-REFERENCE TO RELATED APPLICATIONS

This application claims the benefit of U.S. Provisional Application Ser. No. 60/486,955, filed Jul. 14, 2003.

### BACKGROUND

1. Technical Field

The present invention relates to a tool configuration adapted to receive two or more inspection systems onto/around a robot and serviced/scheduled by a single controller.

2. Background Information

Over the past several decades, the semiconductor has exponentially grown in use and popularity. The semiconductor has in effect revolutionized society by introducing computers, electronic advances, and generally revolutionizing many previously difficult, expensive and/or time consuming mechanical processes into simplistic and quick electronic processes. This boom in semiconductors has been fueled by an insatiable desire by business and individuals for computers and electronics, and more particularly, faster, more advanced computers and electronics whether it be on an assembly line, on test equipment in a lab, on the personal computer at one's desk, or in the home electronics and toys.

The manufacturers of semiconductors have made vast improvements in end product quality, speed and performance as well as in manufacturing process quality, speed and performance. However, there continues to be demand for faster, more reliable and higher performing semiconductors. To assist these demands, better inspection is necessary to increase yields. Better inspection is inspection that assists in driving down the cost of ownership of a chip fab. It is desirable to provide a tool with a very small footprint (area of floor space occupied by the tool), an assortment of inspection technologies centered in one place, and extendibility.

Most current inspection tools are designed for a specific single type of inspection, metrology or review such as any one of the following: two dimensional (2D) front side, three dimensional (3D) front side, edge, back side, review, metrology, wafer bowing, microscopy and the like, and are often also designed for a particular stage of the wafer processing such as any one of the following: bare wafer, photolithography, active topography, metal interconnect, etch, chemical mechanical polish (CMP), final passivation, etc. As a result, tools are not interchangeable from line to line, from stage to stage, or for different steps—and this is disadvantageous for users. Furthermore, the inspection or metrology systems in duplicate or more cannot be coupled together for use with a single handler to increase throughput.

### SUMMARY

One embodiment of the present invention provides a semiconductor inspection tool. The semiconductor inspection tool includes a robot, a first wafer carrier proximate the robot, a first wafer inspection module proximate the robot, a second wafer inspection module proximate the robot, and a controller configured for controlling the robot to pass wafers between the first wafer carrier, the first wafer inspection module, and the second wafer inspection module.

### BRIEF DESCRIPTION OF THE DRAWINGS

Preferred embodiments of the invention, illustrative of the best mode in which applicant has contemplated applying the principles, are set forth in the following description and are shown in the drawings and are particularly and distinctly pointed out and set forth in the appended claims.

FIG. 1 is a perspective diagram illustrating one embodiment of a semiconductor inspection tool.

FIG. 2 is a block diagram illustrating one embodiment of the semiconductor inspection tool.

FIG. 3 is a flow diagram illustrating one embodiment of a method for using the semiconductor inspection tool.

### DETAILED DESCRIPTION

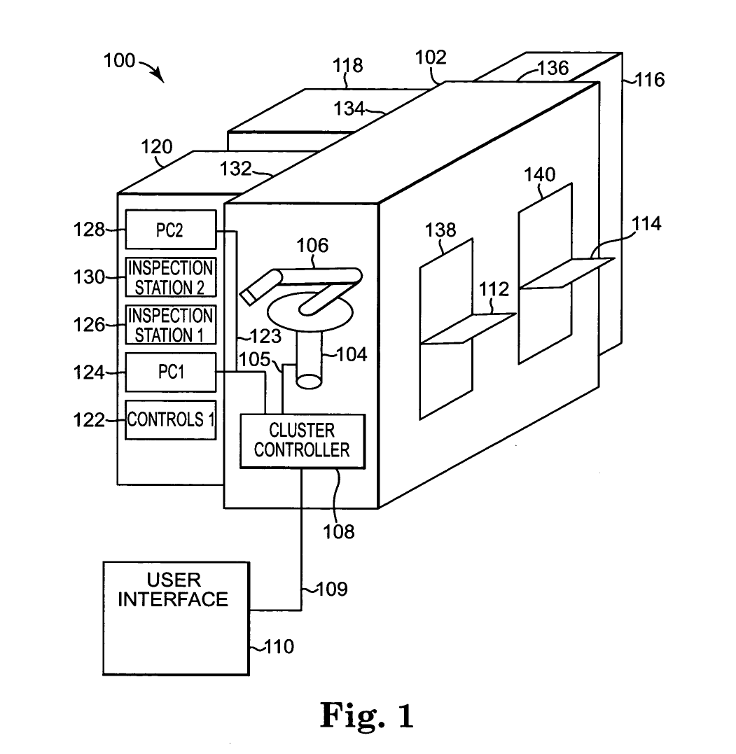

FIG. 1 is a perspective diagram illustrating one embodiment of a semiconductor inspection tool 100. Semiconductor inspection tool 100 includes a handler 102, inspection modules 116, 118, and 120, wafer carriers or loadports 112 and 114, and user interface 110. Handler 102 includes a robot 104, a cluster controller 108, and module ports 132, 134, 136, 138, and 140. Robot 104 includes an arm 106. Module 120 includes inspection station one 126, inspection station two 130, personal computer (PC) one 124, PC two 128, and controls one 122. In one embodiment, semiconductor inspection tool 100 is an automated system that is configured to inspect substrates, such as semiconductor wafers and semiconductor die.

Semiconductor inspection tool 100 of the present invention is configured to receive two or more inspection modules, such as modules 116, 118, and 120, which are each configured to receive one or more inspection stations, such as inspection station one 126 and inspection station two 130. Each inspection station can be a defect detection system, metrology system, or review system. The modules are clustered around robot 104 and serviced/scheduled by a single controller, such as cluster controller 108, thereby reducing the handling and inspection data flow costs.

Cluster controller 108 is electrically coupled to user interface 110 through communication link 109, robot 104 through communication link 105, and PC one 124 and PC two 128 through communication link 123. Module 120 is removably coupled to handler 102 at module port 132. Module 118 is removably coupled to handler 102 at module port 134. Module 116 is removably coupled to handler 102 at module port 136. Wafer carrier 112 is removably coupled to handler 102 at module port 138. Wafer carrier 114 is removably coupled to handler 102 at module port 140. In one embodiment, wafer carrier 112 and wafer carrier 114 comprise removable wafer cassettes for holding and transporting semiconductor wafers between semiconductor inspection tool 100 and other wafer processing equipment.

In one embodiment, handler 102 can include any suitable number of module ports for removably coupling any suitable number of modules to handler 102. In one embodiment, each module has common controls, such as controls one 122, for providing power, input/output, and other controls for each inspection station in the module, such as inspection station one 126 and inspection station two 130. PC one 124 controls the inspection of wafers on inspection station one 126, and PC two 128 controls the inspection of wafers on inspection station two 130. PC one 124 provides inspection results data for inspection station one 126, and PC two 128 provides inspection results data for inspection station two 130. The inspection results from PC one 124 and PC two 128 are passed to cluster controller 108 through communication link 123.

Cluster controller 108 passes the inspection results to user interface 110 for display. In one embodiment, cluster controller 108 correlates the inspection data received from PC one 124, PC two 128, and other PCs in other modules used to control other inspection stations, to provide a single display of an inspected wafer, including the correlated inspection results derived from the individual inspection results from each inspection station in semiconductor inspection tool 100.

Inspection results are displayed on user interface 110. In one embodiment, user interface 110 includes a monitor, keyboard, mouse, and/or any other suitable input/output device for a user to interface with cluster controller 108 to view inspection results.

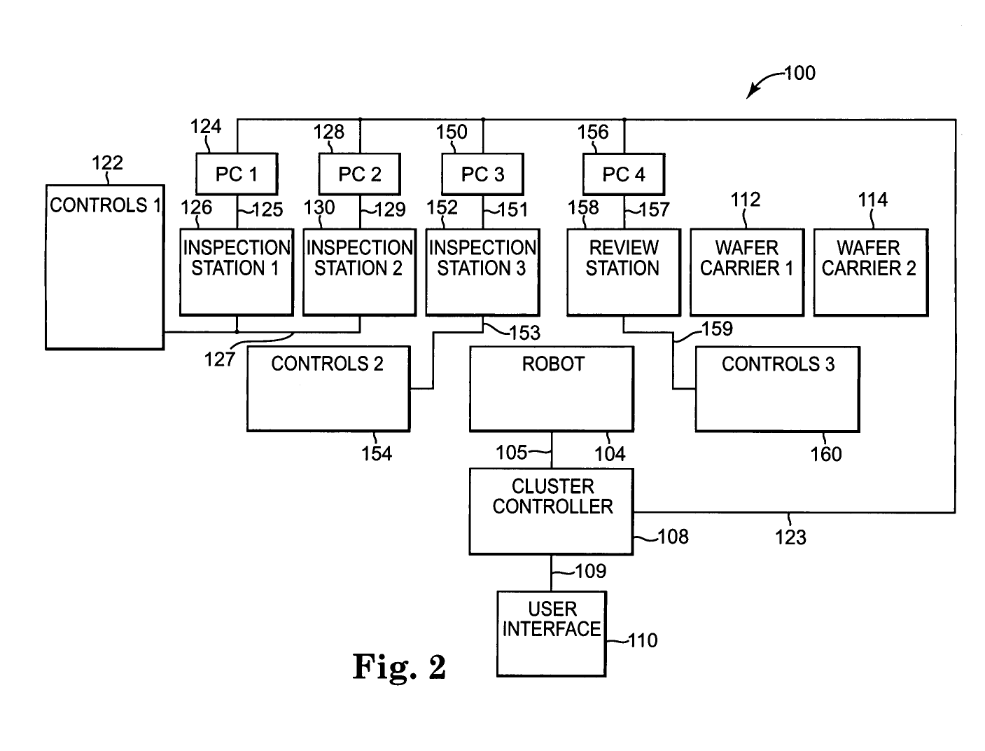

FIG. 2 is a block diagram illustrating one embodiment of semiconductor inspection tool 100. In addition to cluster controller 108, robot 104, user interface 110, controls one 122, PC one 124, inspection station one 126, PC two 128, inspection station two 130, wafer carrier one 112, and wafer carrier two 114 shown in FIG. 1, the embodiment of semiconductor inspection tool 100 shown in FIG. 2 also includes PC three 150, inspection station three 152, controls two 154, PC four 156, review station 158, and controls three 160.

Controls one 122 is electrically coupled to inspection station one 126 and inspection station two 130 through communication link 127. Inspection station one 126 is electrically coupled to PC one 124 through communication link 125. Inspection station two 130 is electrically coupled to PC two 128 through communication link 129. Controls two 154 is electrically coupled to inspection station three 152 through communication link 153. Inspection station three 152 is electrically coupled to PC three 150 through communication link 151. Controls three 160 is electrically coupled to review station 158 through communication link 159. Review station 158 is electrically coupled to PC four 156 through communication link 157. Cluster controller 108 is electrically coupled to robot 104 through communication link 105, user interface 110 through communication link 109, and PC one 124, PC two 128, PC three 150, and PC four 156 through communication link 123.

In one embodiment, inspection station three 152, PC three 150, and controls two 154 are part of module 118 (FIG. 1), and review station 158, PC four 156, and controls three 160 are part of module 116 (FIG. 1). In other embodiments, module 116 and module 118 can each include multiple inspection stations in any suitable combination.

Controls two 154 provides power, input/output, and other controls for inspection station three 152. PC three 150 controls the inspection of wafers on inspection station three 152 and provides inspection results data for inspection station three 152. The inspection results from PC three 150 are passed to cluster controller 108 through communication link 123. Controls three 160 provides power, input/output, and other controls for review station 158. PC four 156 controls the review of wafers on review station 158 and provides review results data for review station 158. The review results from PC four 156 are passed to cluster controller 108. Cluster controller 108 passes the inspection results and review data to user interface 110 for display.

The design of semiconductor inspection tool 100 makes semiconductor inspection tool 100 extremely flexible and provides multiple inspection capabilities within a single tool. Furthermore, the design allows more than one module of the same type to be attached to the cluster to improve throughput or add reliability. For the owner and user, this means a better price/performance ratio than a stand-alone tool with dedicated handler.

Semiconductor inspection tool 100 is also expandable, since it provides an ability to add inspection modules as the fab grows to accommodate fab capacity issues. Semiconductor inspection tool 100 also allows for a portion of the tool to be switched out if it breaks, malfunctions, or becomes obsolete without retiring the entire tool. In sum, this multi-faceted, flexible, expandable, easily tailored tool 100 is designed, in one embodiment, for a variety of inspection steps, including after develop inspection, macro defect inspection, and final quality inspection, and includes front side, back side, and edge capabilities for both patterned and unpatterned wafers. In the preferred embodiment, at least one wafer carrier (e.g., wafer carrier 112 and/or 114) is required, and at least one inspection or metrology station (e.g., station 126, 130, and/or 152) is required.

Handler 102 is a system that is designed in one embodiment to include all of the wafer or other substrate handling robotics. Preferably, cluster controller 108 is electrically communicating with modules 112-120 from handler 102. Handler 102 is designed to have multiple module ports 132-140 in its skin or cover on which modules 112-120 are easily attached in a secure manner that assures proper atmospheric or vacuum communication and meets clean room standards. The module ports 132-140 are also configured such that the modules may readily interact with robot 104.

The modules 112-120 may include any type of metrology, inspection, or other desirable station for use in a semiconductor or microelectronics fab. Some possibilities include two dimensional (2D) front side, three dimensional (3D) front side, edge, back side, review, metrology, wafer bowing, microscopy, film thickness, chemical mechanical polishing (CMP) dishing and/or erosion, and critical dimension (CD) metrology at the macro or micro level.

In one embodiment, handler 102 has any of two, three, four, five, or more modules attached to and interacting with it. It is preferable that at least one module be some form of wafer carrier so as to provide a supply of wafers to review, inspect, or measure. Beyond this, the modules may all be of the same type (for example, all of them may include 2D front side stations), or may include all different types of stations (for example, a 2D front side, edge, and back side inspection station may be present on a four module tool with a loadport), or a mix of two or more like stations with one or more dissimilar stations.

Some specific examples are as follows: (1) a pair of loadports (such as an Ultraport as sold by August Technology) and a 2D or 3D inspection module (such as a NSX, 3DI, or AXi inspection module as designed by August Technology based off of its stand alone NSX, 3Di, and AXi series); (2) a pair of loadports and three inspection or metrology modules; (3) a loadport, a 2D inspection module, and a 3D inspection module; (4) a loadport, a 2D and 3D inspection module, and an edge inspection module; (5) a loadport, a 2D and 3D inspection module, an edge inspection module, and a back side inspection module; (6) a loadport, a review station, and a 2D inspection module; or (7) a loadport, a 2D inspection module, and a second 2D inspection module. These are but a few possibilities as semiconductor inspection tool 100 is very flexible, and in one form of the invention, tool 100 is the assembly of two or more inspection systems onto/around a robot and serviced/scheduled by a single controller.

This unique tool 100 according to one embodiment saves process step time, in that the factory does not need to move the wafers to two separate tools to perform the inspections, and footprint, because the robot handler is re-used. In addition, this unique tool 100 according to one embodiment extends modularity with the ability to add a plurality of inspection modules.

In another embodiment, any of the modules (e.g., modules 112-120) may include more than one inspection station therein to further improve the price/performance ratio and cost of ownership for the customer. An example would be a single module, which includes both edge inspection and back side inspection systems, or multiple like systems such as a pair of 2D inspection stations. Two or more inspection stations of the same type with a relatively slower inspection process can be included in semiconductor inspection tool 100 to load balance one inspection station with a relatively faster inspection process in semiconductor inspection tool 100. For example, three or four 3D inspection stations, which are relatively slow compared to 2D inspection stations, can be used to load balance a single 2D inspection station. Using station configurations such as this, the throughput of semiconductor inspection tool 100 is maximized.

The tool 100 as a whole thus has multiple integrated inspection and metrology capabilities at any time in one embodiment, and can at any time be changed, upgraded, etc. These capabilities include for example: wafer front side patterned and unpatterned inspection, wafer back side inspection, wafer edge inspection, and wafer bowing all with 100% coverage. In one form of the invention, the front side inspection includes macro defects (e.g., greater than 10 um), visual anomalies (e.g., greater than 10 um, such as patterning defects, scratches, residue and process complications), and non-critical layer defects, such as pattern registration and CD measurements. In one embodiment, the back side inspection includes macro defects (such as particles, surface anomalies, and repeating), scratches (such as large visual signature and repeating), visual anomalies (such as wetting/staining/haze and powder/coatings), and may be correlated to front side results. In one form of the invention, the edge inspection includes chipouts (e.g., greater than 10 um), edge condition (such as films and contamination), edge bead removal (EBR) signature (such as sampled edge measurement, 100% consistency check, and 100% contamination check) and may be correlated to notch and front side results.

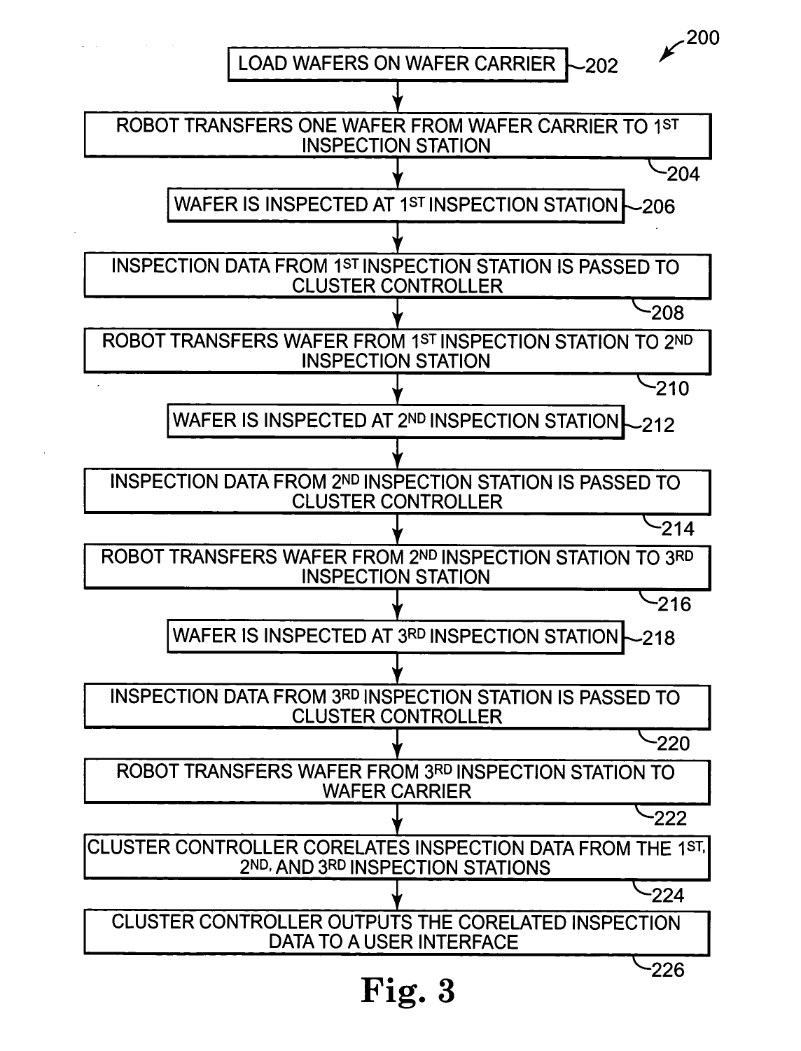

FIG. 3 is a flow diagram illustrating one embodiment of a method 200 for using semiconductor inspection tool 100. At 202, wafers are loaded on a wafer carrier, such as wafer carrier 112 or wafer carrier 114. At 204, robot 104 uses arm 106 to transfer one wafer from wafer carrier 112 or wafer carrier 114 to a first inspection station, such as inspection station one 126. At 206, the wafer is inspected at the first inspection station. At 208, the inspection data obtained from the inspection, such as the inspection data from PC one 124, is passed to cluster controller 108 through communication link 123.

At 210, robot 104 transfers the wafer from the first inspection station to a second inspection station, such as inspection station two 130. At 212, the wafer is inspected at the second inspection station. At 214, the inspection data obtained from the second inspection station, such as the inspection data from PC two 128, is passed to cluster controller 108 through communication link 123. At 216, robot 104 transfers the wafer from the second inspection station to a third inspection station, such as inspection station three 152. At 218, the wafer is inspected at the third inspection station. At 220, the inspection data obtained from the inspection, such as the inspection data from PC three 150, is passed to cluster controller 108 through communication link 123. At 222, robot 104 transfers the wafer from the third inspection station to wafer carrier 112 or wafer carrier 114. At 224, cluster controller 108 correlates the inspection data from the first, second, and third inspection stations. At 226, cluster controller 108 outputs the correlated inspection data to user interface 110.

In one embodiment, if a wafer is found defective at one inspection station, the specified inspection flow is modified based on the inspection results. For example, if a wafer is found defective at the first inspection station, robot 104 transfers the wafer back to wafer carrier 112 or wafer carrier 114 without inspecting the wafer at the second inspection station and the third inspection station. In another embodiment, if a wafer is found defective at one inspection station, the wafer is transferred to a review station for review, such as review station 158.

In one embodiment, semiconductor inspection tool 100 is used to inspect two sets of wafers, such as wafers from wafer carrier 112 and wafers from wafer carrier 114, at different inspection stations within semiconductor inspection tool 100. For example, wafers from wafer carrier 112 can be simultaneously inspected one at a time at a back side inspection station while wafers from wafer carrier 114 are inspected one at a time at a front side inspection station within semiconductor inspection tool 100. In addition, in one embodiment, while the wafers are being inspected, another wafer can be reviewed in a review station within semiconductor inspection tool 100, such as review station 158.

Semiconductor inspection tool 100 provides improved yields in one embodiment through improved defect detection, minimized wafer handling, and powerful data analysis techniques. Semiconductor inspection tool 100 also maximizes capital efficiency in one embodiment through high throughput capability, maximum flexibility enabling a single tool to have application throughout the manufacturing process, and maximum capability eliminating the need for multiple tool sets. In one embodiment, semiconductor inspection tool 100 eliminates manual inspection through detection capability that outperforms human inspection in terms of consistency and repeatability, automatic defect classification, and easy implementation and operation.

Accordingly, the invention as described above and understood by one of skill in the art is simplified, provides an effective, safe, inexpensive, and efficient device, system and process that achieves all the enumerated objectives, provides for eliminating difficulties encountered with prior devices, systems and processes, and solves problems and obtains new results in the art.

In the foregoing description, certain terms have been used for brevity, clearness, and understanding; but no unnecessary limitations are to be implied therefrom beyond the requirement of the prior art, because such terms are used for descriptive purposes and are intended to be broadly construed.

Moreover, the invention's description and illustration is by way of example, and the invention's scope is not limited to the exact details shown or described.

Having now described the features, discoveries and principles of the invention, the manner in which it is constructed and used, the characteristics of the construction, and the advantageous, new and useful results obtained; the new and useful structures, devices, elements, arrangements, parts and combinations, are set forth in the appended claims.

1. A semiconductor inspection tool comprising:
a robot;
a first wafer carrier proximate the robot;
a first wafer inspection module proximate the robot;
a second wafer inspection module proximate the robot; and
a controller configured for controlling the robot to pass wafers between the first wafer carrier, the first wafer inspection module, and the second wafer inspection module.

2. The semiconductor inspection tool of claim 1, wherein the first wafer inspection module and the second wafer inspection module are removably coupled to the semiconductor inspection tool.

3. The semiconductor inspection tool of claim 1, further comprising a review station module proximate the robot, and wherein the controller is configured for controlling the robot to pass wafers between the first wafer carrier, the first wafer inspection module, the second wafer inspection module, and the review station module.

4. The semiconductor inspection tool of claim 1, further comprising a second wafer carrier proximate the robot, and wherein the controller is configured for controlling the robot to pass wafers between the first wafer carrier, the second wafer carrier, the first wafer inspection module, and the second wafer inspection module.

5. The semiconductor inspection tool of claim 1, wherein the first wafer inspection module comprises one of a two dimensional front side inspection system, a three dimensional front side inspection system, an edge inspection system, and a back side inspection system.

6. The semiconductor inspection tool of claim 1, wherein the first wafer inspection module comprises one of a metrology system, a wafer bowing system, a microscopy system, a film thickness system, a chemical mechanical polishing dishing system, a chemical mechanical polishing erosion system, a macro critical dimension metrology system, and a micro critical dimension metrology system.

7. The semiconductor inspection tool of claim 1, wherein the first wafer inspection module is configured for inspecting wafers at one of a bare wafer stage, a photolithography stage, an active topography stage, a metal interconnect stage, an etch stage, a chemical mechanical polish stage, and a final passivation stage.

8. The semiconductor inspection tool of claim 1, wherein the first wafer carrier comprises a removable wafer cassette.

9. The semiconductor inspection tool of claim 1, wherein the first wafer inspection module and the second wafer inspection module are substantially identical.

10. The semiconductor inspection tool of claim 1, wherein the first wafer inspection module comprises a first inspection station and a second inspection station.

11. The semiconductor inspection tool of claim 10, wherein the first inspection station comprises a first computer for controlling the first inspection station and the second inspection station comprises a second computer for controlling the second inspection station.

12. The semiconductor inspection tool of claim 10, wherein the first wafer inspection module comprises a common controller for operating the first inspection station and the second inspection station.

13. The semiconductor inspection tool of claim 1, further comprising:
a user interface electrically coupled to the controller, the user interface configured for displaying inspection results from the first wafer inspection module and the second wafer inspection module.

14. The semiconductor inspection tool of claim 13, wherein the controller is configured for correlating inspection results from the first wafer inspection module and the second wafer inspection module, and wherein the user interface is configured for displaying results of the correlation.

15. A semiconductor inspection tool comprising:
a handler including a robot;
a wafer carrier module removably coupled to the handler;
a first inspection module removably coupled to the handler;
a second inspection module removably coupled to the handler;
a controller electrically coupled to the robot, the controller configured to control the robot to pass wafers between the wafer carrier module, the first inspection module, and the second inspection module.

16. The semiconductor inspection tool of claim 15, wherein the wafer carrier module, the first inspection module, and the second inspection module are removably coupled to the handler in a secure manner to provide appropriate atmospheric conditions.

17. The semiconductor inspection tool of claim 15, wherein the wafer carrier module, the first inspection module, and the second inspection module are removably coupled to the handler in a secure manner that meets clean room standards.

18. The semiconductor inspection tool of claim 15, wherein the first inspection module comprises a first inspection station and a second inspection station.

19. The semiconductor inspection tool of claim 18, wherein the first inspection module comprises controls configured for controlling the first inspection station and the second inspection station.

20. The semiconductor inspection tool of claim 18, wherein the first inspection module comprises a first computer configured for operating the first inspection station to obtain first inspection results and a second computer configured for operating the second inspection station to obtain second inspection results.

21. The semiconductor inspection tool of claim 20, further comprising:
a user interface configured for displaying the first inspection results and the second inspection results.

22. The semiconductor inspection tool of claim 21, wherein the user interface is configured to display third inspection results of the second inspection module.

23. The semiconductor inspection tool of claim 22, wherein the controller is configured to correlate the first inspection results, the second inspection results, and the third inspection results, and wherein the user interface is configured for displaying results of the correlation.

24. A method for inspecting a semiconductor wafer, the method comprising:
providing an inspection tool comprising a handler including a robot, a first wafer carrier module removably coupled to the handler, a first wafer inspection module removably coupled to the handler, and a second wafer inspection module removably coupled to the handler; and
controlling the robot with a controller to pass wafers between the first wafer carrier module, the first wafer inspection module, and the second wafer inspection module.

25. The method of claim 24, further comprising:
transferring with the robot a first wafer from the first wafer carrier module to the first wafer inspection module; and
inspecting the first wafer in the first wafer inspection module to obtain first inspection results.

26. The method of claim 25, further comprising:
transferring with the robot the first wafer from the first wafer inspection module to the second wafer inspection module; and
inspecting the first wafer in the second wafer inspection module to obtain second inspection results.

27. The method of claim 26, further comprising:
transferring with the robot the first wafer from the second wafer inspection module to the first wafer carrier module.

28. The method of claim 25, further comprising:
correlating the first inspection results to the second inspection results.

29. The method of claim 25, wherein the inspection tool includes a second wafer carrier module removably coupled to the handler, the method further comprising:
transferring with the robot a second wafer from the second wafer carrier module to the second wafer inspection module; and
inspecting the second wafer in the second wafer inspection module to obtain second inspection results.

30. The method of claim 29, further comprising:
transferring with the robot the first wafer from the first wafer inspection module to the first wafer carrier module; and
transferring with the robot the second wafer from the second wafer inspection module to the second wafer carrier module.

31. The method of claim 24, wherein the inspection tool includes a third wafer inspection module removably coupled to the handler, the method further comprising:
specifying an inspection flow for a wafer through the first wafer inspection module, the second wafer inspection module, and the third wafer inspection module to load balance the inspection tool;
inspecting the wafer at one of the first wafer inspection module, the second wafer inspection module, and the third wafer inspection module based on the inspection flow to obtain inspection results; and
modifying the specified inspection flow for the wafer through the first wafer inspection module, the second wafer inspection module, and the third wafer inspection module based on the inspection results.

32. The method of claim 31, wherein the inspection tool includes a review station, the method further comprising:
transferring the wafer with the robot to the review station based on the inspection results.

33. The method of claim 31, wherein modifying the specified inspection flow for the wafer comprises the wafer bypassing at least one of the first wafer inspection module, the second wafer inspection module, and the third wafer inspection module based on the inspection results.
